(19) United States
(12) Patent Application Publication
(10) Pub. No.: US 2009/0254586 A1
(43) Pub. Date: Oct. 8, 2009

(54) Updated Bookmark Associations

(75) Inventor: Peter T. Barrett, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/062,493

(22) Filed: Apr. 3, 2008

(51) Int. Cl. G06F 17/30

(52) U.S. Cl. 707/104.1; 707/E17.009

(57) ABSTRACT

Updated bookmark associations is described. In embodiment(s), a bookmark save event can be received from a media device when a bookmark is initiated while a video stream of media content is rendered by the media device, such as when the bookmark save event is initiated by a viewer at the media device. A bookmark definition that correlates the bookmark with the media content from which it was initiated can be determined and maintained. Contextual aspects of the bookmark can then be determined to identify bookmark associated items that are associated with the media content. Additional bookmark definitions that each correlate a bookmark associated item with the bookmark can also be determined. When a request for the bookmark is received, the bookmark definitions can be updated along with the bookmark associated items.

### BACKGROUND

Viewers have an ever-increasing selection of media content to choose from, such as television programming, on-demand movies and music, and/or recorded media content that is available for streaming from a content distributor to a media device. For example, scheduled television programming can be recorded at the time of broadcast when initially distributed for viewing, and can then be made available for on-demand viewing when requested via a media device. This is commonly referred to as Network Digital Video Recording (nDVR) and a viewer can request the recorded television content, such as movies and television programs, when convenient for the viewer.

A viewer can request the media content for viewing and/or playback from any number of various media devices, such as wired and/or wireless devices, to include a television client device (e.g., a television set-top box or a digital video recorder (DVR)), a broadcast-enabled computer device, a portable media content player, and the like. Given the ever-increasing selection and variety of media content that is available, as well as the many devices that can be utilized for viewing and/or playback of the media content, users may want to locate media content (e.g., television programming, movie choices, music, etc.) that is of interest to them, send or receive recommended media content, and organize the available media content, such as to identify specific media content items and/or specific points of interest in various media content items.

### SUMMARY

This summary is provided to introduce simplified concepts of updated bookmark associations. The simplified concepts are further described below in the Detailed Description. This summary is not intended to identify essential features of the claimed subject matter, nor is it intended for use in determining the scope of the claimed subject matter.

Updated bookmark associations is described. In embodiment(s), a bookmark save event can be received from a media device when a bookmark is initiated while a video stream of media content is rendered by the media device, such as when the bookmark save event is initiated by a viewer at the media device. A bookmark definition that correlates the bookmark with the media content from which it was initiated can be determined and maintained. Contextual aspects of the bookmark can then be determined to identify bookmark associated items that are associated with the media content. Additional bookmark definitions that each correlate a bookmark associated item with the bookmark can also be determined.

In other embodiment(s), the bookmark definitions can be updated along with the bookmark associated items when a request for the bookmark is received. The bookmark definitions can be updated based on a day and/or time when a request for the bookmark is received; based on previous selections of the bookmark associated items that are correlated with the bookmark; based on a profile of a user from which a request for the bookmark is received; and/or based on a media device from which a request for the bookmark is received.

### BRIEF DESCRIPTION OF THE DRAWINGS

Embodiments of updated bookmark associations are described with reference to the following drawings. The same numbers are used throughout the drawings to reference like features and components:

FIG. 1 illustrates an example system in which embodiments of updated bookmark associations can be implemented.

FIG. 2 illustrates another example system in which embodiments of updated bookmark associations can be implemented.

FIG. 3 illustrates example method(s) for updated bookmark associations in accordance with one or more embodiments.

FIG. 4 illustrates example method(s) for updated bookmark associations in accordance with one or more embodiments.

FIG. 5 illustrates various components of an example device which can implement embodiments of updated bookmark associations.

FIG. 6 illustrates various devices and components in an example media content distribution system in which embodiments of updated bookmark associations can be implemented.

### DETAILED DESCRIPTION

Embodiments of updated bookmark associations provide that a bookmark save event can be received from a media device when a bookmark is initiated while a video stream of media content is rendered by the media device. A bookmark can be initiated or created as an identifier or reference that corresponds to a specific piece of media content, or segment thereof. A bookmark can also optionally indicate start and/or end points that define a segment of the media. A viewer or other user can initiate a bookmark save event to “save” or create a bookmark, such as by pressing a “bookmark” selectable button on a remote control device. The viewer can then later request to “view”, “play”, or “share” the bookmark, or bookmark associated items that correlate to the bookmark.

A bookmark that is correlated with the media content from which the bookmark is initiated can be associated with other media content and/or various items based on contextual aspects of the bookmark used to identify bookmark associated items that are associated with the media content. The bookmark includes an aspect or element of context with the media content and can be used to find or determine additional associations between the original media content and other assets. Bookmark definitions are determined that each correlate a bookmark associated item with the bookmark.

A bookmark can be correlated with any number of bookmark associated items, such as the media content itself (e.g., a movie, music video, television program, advertisement, etc.), a scene in the movie, the song of a music video, the music playing in a background of a movie, an episode of a television program, a future episode of the television program, a sporting event, a product or service offered in an advertisement, a person (e.g., actor, actress, character, director) associated with the media content, other recommended media content, a retail service offering products that are associated with the media content, and/or any other related products, services, movies, programs, and various media content that may be associated with the bookmark.

In addition, the various bookmark definitions and corresponding bookmark associated items can be updated when a request for a selected bookmark is received. The bookmark definitions and the corresponding bookmark associated items can be interpreted or updated “live”, such as when the request for the selected bookmark is received. This may also be referred to as “late-binding” a bookmark to update and/or re-determine a context of the bookmark to the various items and other media content. A bookmark user interface can then be displayed at a media device from which a user can select the various media content, products, services, other recommended media content, etc. that has been associated or correlated with a selected bookmark.

While features and concepts of the described systems and methods for updated bookmark associations can be implemented in any number of different environments, systems, and/or various configurations, embodiments of updated bookmark associations are described in the context of the following example systems and environments.

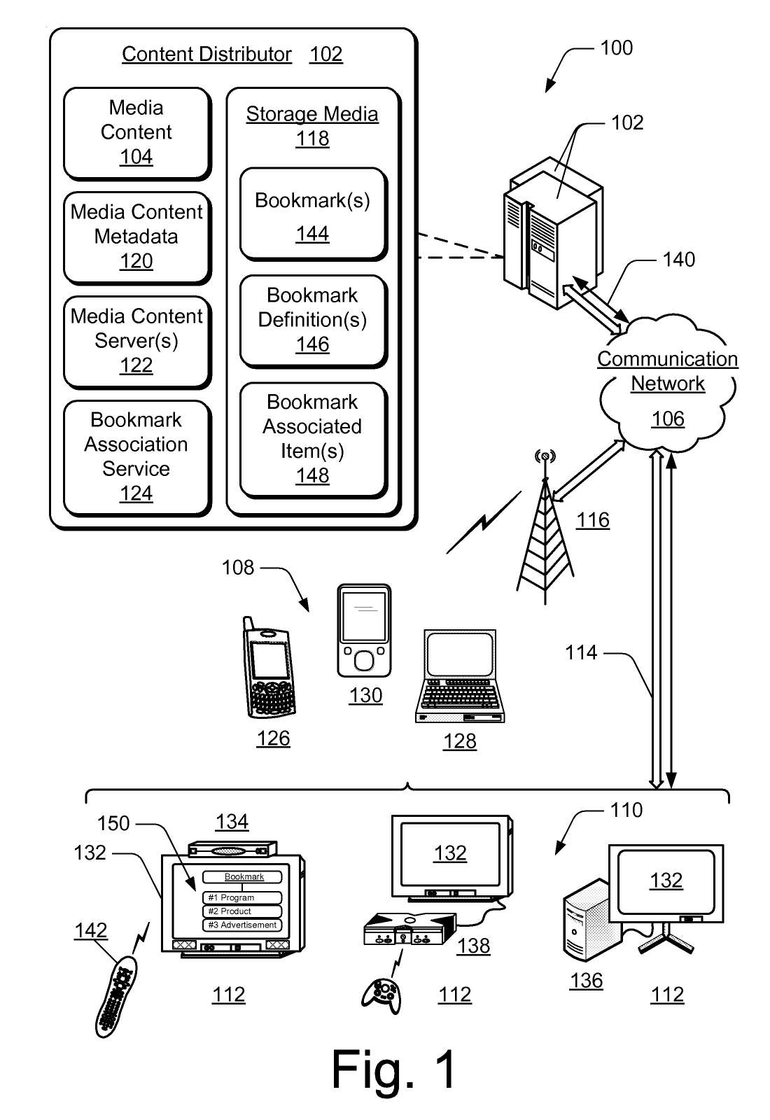

FIG. 1 illustrates an example system 100 in which various embodiments of updated bookmark associations can be implemented. In this example, system 100 includes one or more content distributors 102 that communicate or otherwise provide media content 104 to any number of various media devices via a communication network 106. The various media devices can include wireless media devices 108 as well as other client devices 110 (e.g., wired and/or wireless devices) that are implemented as components in various client systems 112 in a media content distribution system.

The communication network 106 can be implemented to include a broadcast network, an IP-based network 114, and/or a wireless network 116 that facilitates media content distribution and data communication between the content distributors 102 and any number of the various media devices. The communication network 106 can also be implemented as part of a media content distribution system using any type of network topology and/or communication protocol, and can be represented or otherwise implemented as a combination of two or more networks.

In the example system 100, a content distributor 102 includes storage media 118 to store or otherwise maintain various data and media content, such as media content 104, media content metadata 120, and/or recorded on-demand assets. In a Network Digital Video Recording (nDVR) implementation, recorded on-demand assets can be recorded when initially distributed to the various media devices as scheduled television media content. The storage media 118 can be implemented as any type of memory, random access memory (RAM), a nonvolatile memory such as flash memory, read only memory (ROM), and/or other suitable electronic data storage. Content distributor 102 can also include one or more media content servers 122 that are implemented to communicate, or otherwise distribute, the media content 104, media content metadata 120, recorded on-demand assets, and/or other data to any number of the various media devices.

The media content 104 and/or recorded on-demand assets (e.g., recorded media content) can include any type of audio, video, and/or image media content received from any type of media content source. As described throughout, “media content” can include television programs (or programming), advertisements, commercials, music, movies, and on-demand media content. Other media content can include interactive games, network-based applications, and any other audio, video, and/or image content (e.g., to include program guide application data, user interface data, search results and/or recommendations, and the like).

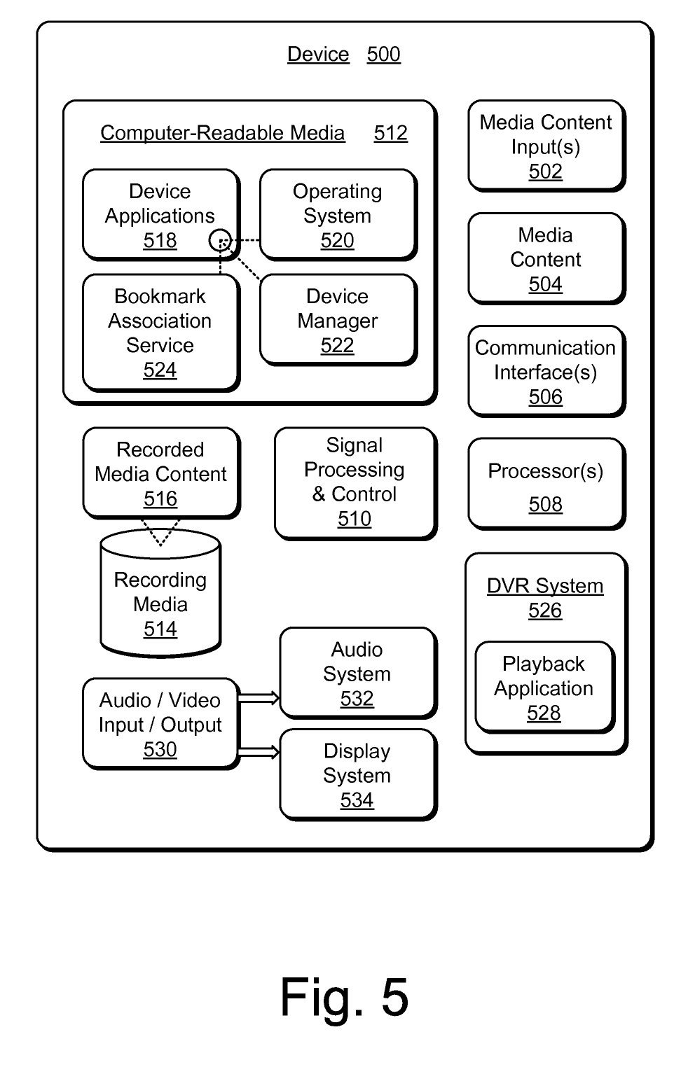

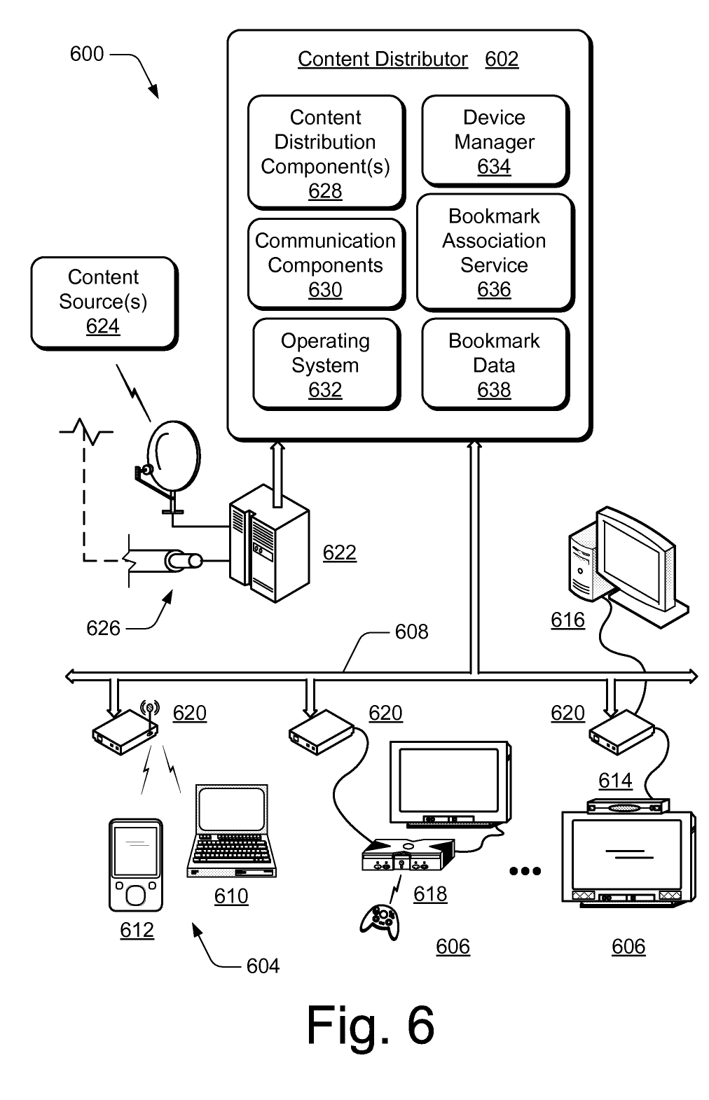

Content distributor 102 also includes a bookmark association service 124 that can be implemented as computer-executable instructions and executed by processor(s) to implement various embodiments and/or features of updated bookmark associations. In addition, a content distributor 102 can be implemented with any number and combination of differing components as further described with reference to the example device shown in FIG. 5 and/or the example content distributor shown in FIG. 6. The bookmark association service 124, as well as other functionality described to implement embodiments of updated bookmark associations, can also be provided as a service apart from the content distributor 102 (e.g., on a separate server or by a third party service).

The wireless media devices 108 can include any type of device implemented to receive and/or communicate wireless data, such as any one or combination of a mobile phone device 126 (e.g., cellular, VoIP, WiFi, etc.), a portable computer device 128, a media device 130 (e.g., a personal media player, portable media player, etc.), and/or any other wireless media device that can receive media content in any form of audio, video, and/or image data. Each of the client systems 112 include a respective client device and display device 132 that together render or playback any form of audio, video, and/or image media content.

A display device 132 can be implemented as any type of a television, high definition television (HDTV), LCD, or similar display system. A client device in a client system 112 can be implemented as any one or combination of a television client device 134 (e.g., a television set-top box, a digital video recorder (DVR), etc.), a computer device 136, a gaming system 138, an appliance device, an electronic device, and/or as any other type of client device that may be implemented to receive media content in any form of audio, video, and/or image data in a media content distribution system.

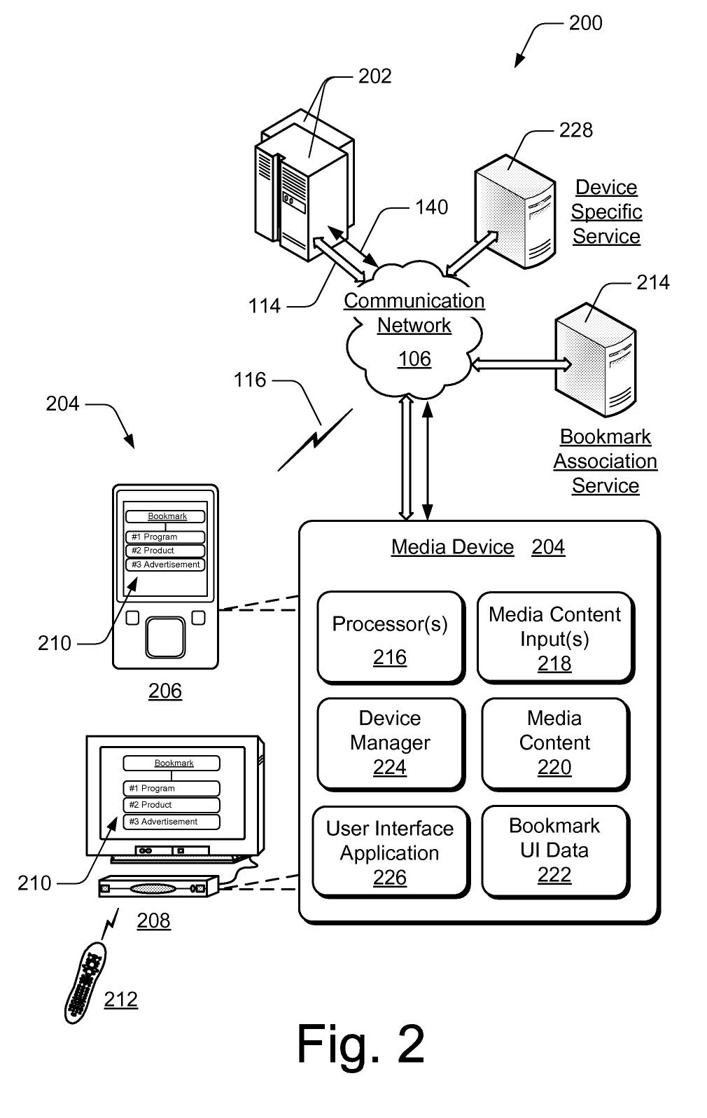

Any of the media devices can be implemented with one or more processors, communication components, memory components, signal processing and control circuits, and a media content rendering system. Further, any of the wireless media devices 108 and/or other client devices 110 can be implemented with any number and combination of differing components as further described with reference to the example media device shown in FIG. 2 and/or the example device shown in FIG. 5. A media device may also be associated with a user or viewer (i.e., a person) and/or an entity that operates the device such that a media device describes logical devices that include users, software, and/or a combination of devices.

Any of the wireless media devices 108 and/or other client devices 110 can communicate with any number of content distributors 102 via a two-way data communication link 140 of the communication network 106. It is contemplated that any one or more of the arrowed communication link 140, IP-based network 114, and wireless network 116, along with communication network 106, facilitate two-way data communication, such as from a media device to a content distributor 102 and vice-versa.

The bookmark association service 124 at content distributor 102 can receive a bookmark save event from any one of the various media devices, such as when a user or viewer at a media device (e.g., television client device 134) initiates a bookmark save event with a remote control device 142. A bookmark save event can be initiated at a media device while a video stream of media content is rendered by the media device. In one or more embodiments, a bookmark save event can be received and maintained or otherwise persisted as a bookmark that is represented as a time indication of a position within the video stream and/or the media content from which the bookmark save event is initiated.

Other techniques to discern a bookmark when initiated as a bookmark save event are contemplated, such as using a Web tool to mark start and end times or points for a video sub-segment of interest, using a remote control button (or buttons) to indicate the start and end times or points of the video sub-segment, indicating via a user interface that an entire video stream of media content is of interest (e.g., selecting a bookmark button on a remote control device to select the program title on a user interface, or similar functionality in a Web environment), and other techniques.

The storage media 118 at content distributor 102 can be utilized to maintain or otherwise store the bookmarks 144 that are received from the various media devices as the bookmark save events. In addition, the storage media 118 can be utilized to maintain bookmark definitions 146 that correspond to the respective bookmarks 144. The bookmark association service 124 and/or the content distributor 102 can also be implemented to correlate the various bookmarks 144 and corresponding bookmark definitions 146 with respective users, media devices, and/or combinations thereof. In various embodiments, the bookmark association service 124 determines contextual aspects of a bookmark to identify bookmark associated items, and determines the bookmark definitions that each correlate a bookmark associated item with the bookmark when a viewer or user requests to view, play, or share a bookmark.

When a bookmark save event is received to create a bookmark 144, the bookmark association service 124 can determine a bookmark definition 146 that correlates the bookmark with the media content from which the bookmark save event is initiated. For example, a bookmark definition 146 can correlate or otherwise associate a bookmark with a particular television program or movie, a scene in the television program or movie, a feature or other aspect of the television program or movie, an advertisement, a product or service offered in or associated with the advertisement, a particular song or music compilation in the television program, the movie, or in a video or streaming music, and/or correlates or otherwise associates the bookmark with any other aspect of the media content from which the bookmark save event was initiated.

The bookmark association service 124 can include various techniques to determine whether the media content from which a bookmark save event is initiated is a movie or other television media content, is an advertisement, has associated music playing in a background of the media content, and/or includes a person associated with the media content. In various embodiments, these techniques to determine the media content can be derived implicitly, or may be derived explicitly and provided in metadata that accompanies a media stream of media content. In one embodiment, the bookmark association service 124 can evaluate the media content metadata 120 that is associated with the media content to determine a type of the media content. Other various techniques can be implemented to discern an advertisement or advertisement pod that is spliced into a video stream of media content, and/or to determine the song playing in a background of a movie or music video.

When a bookmark save event is received to create a bookmark 144, the bookmark association service 124 can be further implemented to determine contextual aspects of the bookmark to identify bookmark associated items that are associated with the media content, and determine additional bookmark definitions 146 that each correlate a bookmark associated item with the bookmark. For example, a viewer may be watching a program series on a movie channel and initiate a bookmark save event during an episode of the program series. The bookmark association service 124 can receive the bookmark save event and determine the various bookmark definitions 146 based on the contextual aspects of the bookmark, and then correlate various bookmark associated items 148 with the bookmark based on the bookmark definitions.

When the bookmark save event is received from a media device during the episode of the program series, the bookmark association service 124 can determine the bookmark definitions 146 to correlate the bookmark with various bookmark associated items 148. By way of example and not limitation, the bookmark associated items can include the current episode of the program series that the viewer is watching; the scene in the program during which the bookmark is initiated; music corresponding to the program and/or the scene in the program; other media content that includes the actors in the program or the particular scene; the next episode of the program series; a DVD compilation of all the episodes in the program series; a documentary that details some aspect of the history that pertains to the program series; recommendations for other programs or movies that the viewer may have an interest in based on the bookmark selection; upcoming special events that will be displayed for viewing on the movie channel that includes the program series; a retail service offering products that are associated with the program; and/or any other related products, services, movies, programs, and various media content that may be associated with the received bookmark.

In another example, a bookmark save event 144 can be initiated at a media device during an advertisement to create a bookmark. The bookmark association service 124 can determine contextual aspects of the bookmark 144 to identify bookmark associated items 148 that are associated with the advertisement, determine bookmark definitions 146 based on the contextual aspects of the bookmark, and correlate the bookmark associated items 148 with the bookmark 144 based on the bookmark definitions. By way of example and not limitation, the bookmark associated items can include the advertisement itself; a product or service offered in the advertisement; other advertisement(s) for the same or similar products; upgrade products and/or accessories for a product offered in the advertisement; a national advertisement for a product if the bookmark is initiated in a local advertisement; a local advertisement for a product if the bookmark is initiated in a national advertisement; a web site that is associated with the product or service offered in the advertisement; and/or any other advertisement-related associations and derivative items.

The bookmark associated items 148 that are correlated or otherwise associated with a bookmark can change over time, and the bookmark association service 124 can be implemented to update the bookmark definitions 146, as well as the bookmark associated items 148. The bookmark definitions 146 and the corresponding bookmark associated items 148 can be interpreted or updated “live”, such as when a viewer initiates a request for a bookmark. This feature may also be referred to as “late-binding” a bookmark to update and/or re-determine the contextual aspects of the bookmark to further identity the various bookmark associated items and other media content. In an embodiment, the bookmark association service 124 can update the bookmark definitions 146, as well as the bookmark associated items 148, when a request for a bookmark 144 is received. The bookmark association service 124 can then provide or otherwise communicate bookmark data to a media device (e.g., television client device 134) for a bookmark user interface 150 that displays a requested bookmark and the various bookmark associated items.

The bookmark association service 124 can also be implemented to interpret and/or update (e.g., late-bind) a bookmark based on other factors or aspects related to the bookmark. In an embodiment, a bookmark definition can be determined or updated based on a day and/or time when a request is received for the bookmark definitions 146 and the bookmark associated items 148. For example, a previously received bookmark save event for a bookmark 144 that was selected during a football game on a Sunday may be associated with a football game on a following Monday night if the request to view the bookmark is received on Monday. Alternatively, the previously received bookmark save event for the bookmark 144 may be associated with a sports highlights show if the request to view the bookmark is received on a day that does not have a football game scheduled for viewing. Similarly, a previously received bookmark save event for a bookmark 144 that was selected during a morning news program may be associated with an evening news program if the request to view the bookmark is received in the evening.

In another embodiment, a bookmark definition can be determined (e.g., late-bind, interpreted, and/or updated) based on a profile of a user from which a request is received for the bookmark definitions 146 and the bookmark associated items 148. A content distributor 102 in a media content distribution system can track previous user requests for various types of media content, such as on-demand movies, streaming music, and the like. Based on previous user requests and media content preferences, the bookmark association service 124 can determine the contextual aspects of the bookmark based on the user and/or user preferences. A bookmark definition can also be determined in combination with a day and/or time, current events, a social context, and/or any other aspect that can be utilized to conform the bookmark definitions 146 to a user.

In another embodiment, a bookmark definition can be determined or updated based on the particular media device from which a request for the bookmark definitions 146 and the bookmark associated items 148 is received. For example, if a bookmark save event is initiated or selected from a mobile phone device 126, then the bookmark association service 124 can determine bookmark definitions to correlate or otherwise associate media content that is accessible to and/or can be rendered for playback or viewing on the mobile phone device.

In another example, a bookmark definition may correlate or associate a movie with a particular bookmark. When a request is received to view or play the bookmark from the mobile phone device 126, the corresponding bookmark associated item may be a poster image of the movie that can be displayed on the mobile phone device. However, when a request is received to view or play the bookmark from the mobile media device 130, the corresponding bookmark associated item may be the movie itself which can be rendered for viewing on the device. Further, if the request for the bookmark is received from the television client device 134, then the corresponding bookmark associated item may be a high-definition (HD) video stream of the movie which can be rendered on an HDTV (e.g., display device 132 coupled to television client device 134). If the request is received from the computer device 136, then the corresponding bookmark associated item may be a Web page for the movie.

In another embodiment, the bookmark associated items 148 can correlate to various video games that are determined from the bookmark definitions 146. When a request for a bookmark is received via the gaming system 138, for example, a user may be provided with a user interface that lists all of the associated video games that can be selected for use via the gaming system. The content distributor 102 may also include a gaming service that is independent of the bookmark association service 124 to distribute the various determined video games to the media devices.

When a viewer or other user requests a bookmark 144 to view, play, or share the bookmark, the bookmark association service 124 can update the bookmark definitions 146 and/or determine additional bookmark representations, resources, assets, and/or functionality that corresponds to the requested bookmark. The bookmark association service 124 can then provide the bookmark definitions 146 that correspond to the bookmark to the media device from which the request for the bookmark is received. Additionally, a request to share a bookmark can be received from a media device, and the requested bookmark can be communicated to an additional media device, such as via an email message.

Although illustrated as described as a component or module of the content distributor 102, the bookmark association service 124 can be implemented as an independent service to implement embodiments of updated bookmark associations. Further, although the bookmark association service 124 is illustrated and described as a single component or module, the bookmark association service 124 can be implemented as several component applications or modules distributed to implement various embodiments of updated bookmark associations.

FIG. 2 illustrates an example system 200 in which various embodiments of updated bookmark associations can be implemented. In this example, system 200 includes one or more content distributors 202 and examples of wired and/or wireless media devices 204, such as a portable media device 206 and a television client device 208. A media device 204 can display various types of media content, as well as a bookmark user interface 210. A viewer can interact with a media device 204 and initiate viewer navigation inputs and selections of bookmark associated items from the bookmark user interface 210 with user inputs, such as on the portable media device 206 or with a remote control input device 212. For example, the bookmark user interface 210 can be selected with remote control inputs to scroll the list of bookmark associated items up and/or down to display and select the various correlated items.

An example of a content distributor is described with reference to content distributor 102 shown in FIG. 1. However, in this example system 200, a bookmark association service 214 is independent and implemented apart from content distributor 202 (e.g., on a separate server or by a third party service). The bookmark association service 214 can be implemented as an optional service and/or as a service that users pay for to receive bookmark associated items and media content and/or a bookmark user interface 210. The content distributor 202, bookmark association service 214, and the media devices 204 can all be implemented for communication with each other via the communication network 106, the IP-based network 114, and/or the wireless network 116.

In the example system 200, a media device 204 includes one or more processors 216 (e.g., any of microprocessors, controllers, and the like), media content inputs 218, and media content 220 (e.g., received media content, media content that is being received, recommended media content, recorded media content, etc.). The media content inputs 218 can include any type of wireless, broadcast, and/or over-the-air inputs via which media content is received. In addition, media device 204 can receive bookmark user interface data 222 from a content distributor 202 and/or the bookmark association service 214 via the media content inputs 218.

Media device 204 can also include a device manager 224 (e.g., a control application, software application, signal processing and control module, etc.) that can be implemented as computer-executable instructions and executed by the processors 216 to implement various embodiments and/or features of updated bookmark associations. The device manager 224 can be implemented to monitor and/or receive selectable inputs (e.g., viewer selections, navigation inputs, etc.) via an input device 212, and initiate communication of user selections back to a content distributor 202 and/or the bookmark association service 214.

Media device 204 can also include a user interface application 226 that can be implemented as computer-executable instructions and executed by the processors 216 to implement various embodiments and/or features of updated bookmark associations. The user interface application 226 can process the bookmark user interface data 222 from which the bookmark user interface 210 can be rendered and/or displayed for viewing at a media device 204.

In an embodiment, the example system 200 may also include a device specific service 228, such as for when a user requests to view or play bookmark(s) from a gaming system. Bookmark associated items can include various associations to video games that have been determined from the bookmark definitions. The bookmark association service 214 and/or the device specific service 228 can provide the bookmark user interface data 222 to the media device 204 (e.g., a gaming system) when a user initiates a request for the bookmark(s). For example, the device specific service 228 can provide a list of video games that can be selected for use via the gaming system from which a request is received to view the bookmarks. The device specific service 228 can be implemented for communication with any of the other media devices, content distributors, and services via the communication network 106, the IP-based network 114, and/or the wireless network 116.

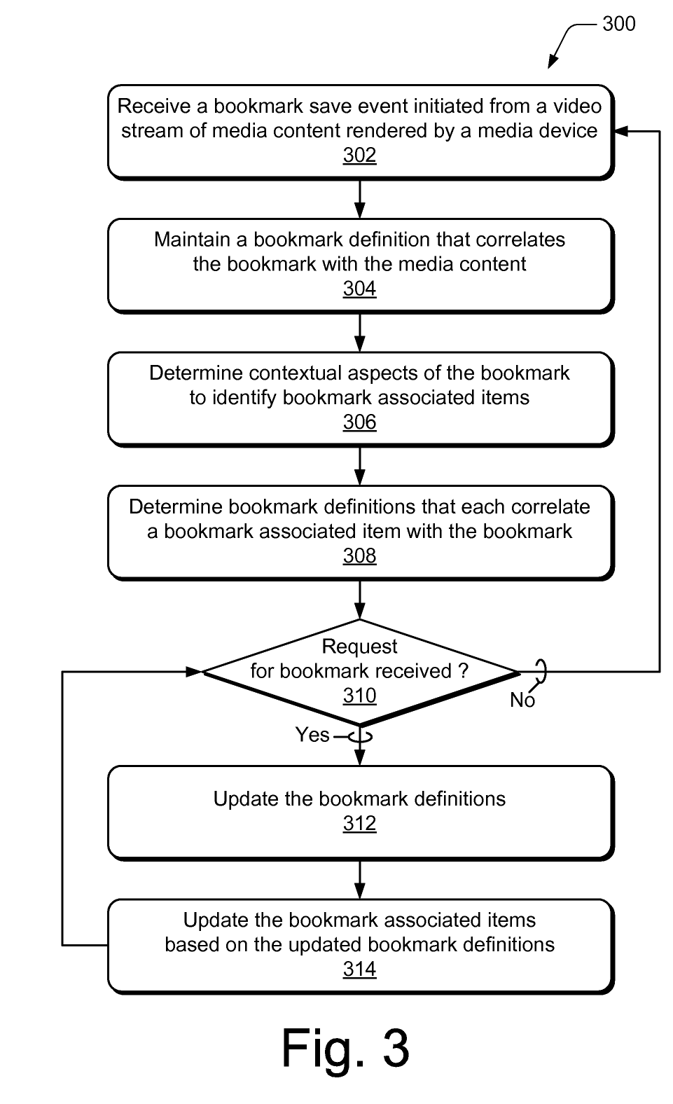

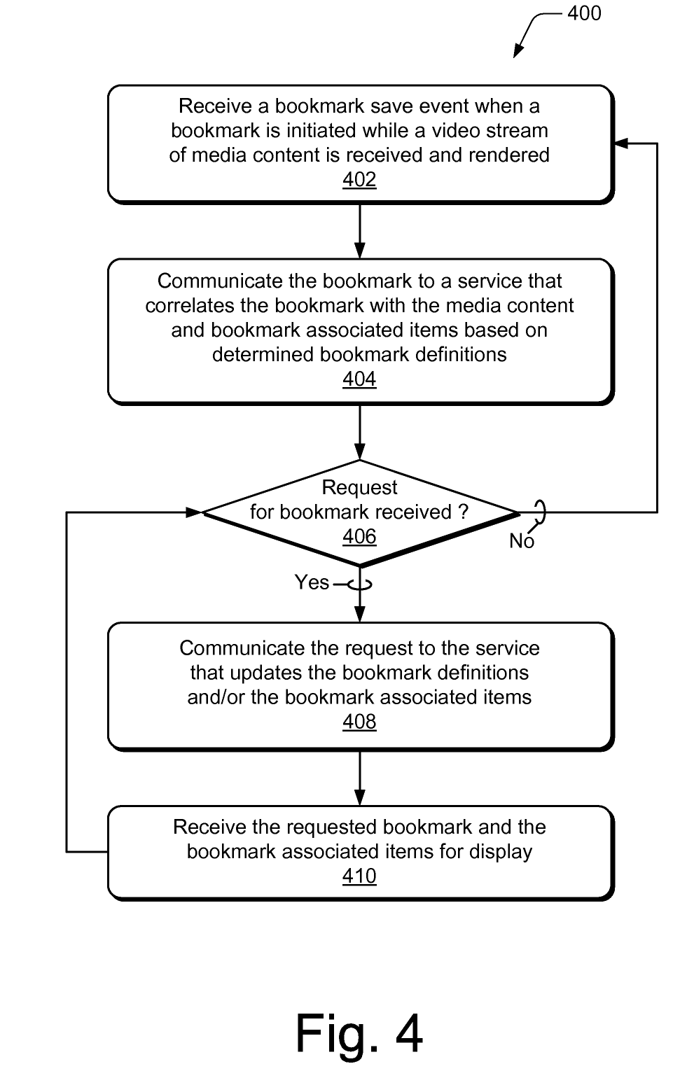

Example methods 300 and 400 are described with reference to respective FIGS. 3 and 4 in accordance with one or more embodiments of updated bookmark associations. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example methods 300 and 400 may be described in the general context of computer-executable instructions. Generally, computer-executable instructions can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of updated bookmark associations. The order in which the method is described is not intended to be construed as a limitation, and any number of the described method blocks can be combined in any order to implement the method, or an alternate method.

At block 302, a bookmark save event is received from a media device when a bookmark is initiated while a video stream of media content is rendered by the media device. For example, the bookmark association service 124 at content distributor 102 (FIG. 1) receives a bookmark save event that is selected or otherwise initiated by a user at a media device, such as when the user is watching a movie and initiates a bookmark to identify the movie, a scene in the movie, and/or some other feature or aspect of the movie.

At block 304, a bookmark definition that correlates the bookmark with the media content is maintained. For example, content distributor 102 includes storage media 118 that maintains selected bookmarks 144 as well as bookmark definitions 146 that correlate or otherwise associate a selected bookmark with the media content from which it was selected. If a bookmark save event is initiated by a user during an advertisement, then a bookmark definition correlates the bookmark with the advertisement and/or with a product or service offered in the advertisement. If a bookmark save event is initiated by a user while watching a movie, then a bookmark definition correlates the bookmark with the movie and/or a scene in the movie.

At block 306, contextual aspects of the bookmark are determined to identify bookmark associated items that are associated with the media content. For example, the bookmark association service 124 at content distributor 102 defines what the bookmark represents in a context to bookmark associated items that are associated with the media content, and at block 308, bookmark definitions are determined that each correlate a bookmark associated item with the bookmark. The bookmark association service 124 can determine the bookmark definitions 146 to correlate or otherwise associate a bookmark with other media content, such as other programs and/or movies that a viewer may be interested in, products that may be associated with the media content from which the bookmark is selected, advertisements for products and services that are related to the media content, and/or music associated with the media content. The bookmark associated items can be correlated with the bookmark based on the bookmark definitions.

At block 310, a determination is made as to whether a request for a bookmark is received. For example, a user or viewer at a media device can initiate a request for previously selected bookmarks (and the bookmark associated items), to include requests such as a bookmark view event, a bookmark play event, or a bookmark share event. If a request for the bookmark is not received (i.e., “no” from block 310), then the method continues at block 302 to receive additional bookmark save events. If a request for the bookmark is received (i.e., “yes” from block 310), then at block 312, the bookmark definitions are updated (e.g., re-interpreted). The bookmark associated items that are associated with a bookmark can change over time, and the bookmark association service 124 updates or re-interprets the bookmark definitions 146, as well as the bookmark associated items 148 at block 314.

In various embodiments, the bookmark definitions 146 and bookmark associated items 148 can be updated (e.g., late-binded or interpreted) based on a day and/or time when a request is received for a bookmark. The bookmark definitions 146 and bookmark associated items 148 can also be updated based on a profile of a user from which the request for a bookmark is received, based on a media device from which the request for the bookmark is received, and/or based on previous media content selections by a user. The updated bookmark definitions 146 and the corresponding bookmark associated items 148 can then be communicated to a media device for display, such as in a list in the bookmark user interface 150.

FIG. 4 illustrates example method(s) 400 of updated bookmark associations. The order in which the method is described is not intended to be construed as a limitation, and any number of the described method blocks can be combined in any order to implement the method, or an alternate method.

At block 402, a bookmark save event is received at a media device when a bookmark is initiated while a video stream of media content is received and rendered at the media device. For example, a media device 204 (FIG. 2) receives a bookmark save event that is selected or otherwise initiated by a user at the media device that renders the media content. At block 404, the bookmark save event is communicated to a service that correlates the bookmark with the media content from which the bookmark save event was selected, and with other media content and/or items based on determined bookmark definitions. For example, media device 204 communicates a bookmark save event to the bookmark association service 214 that determines the bookmark associated items.

At block 406, a determination is made as to whether a request for a bookmark is received. For example, a user or viewer at media device 204 can request previously selected bookmarks (and the corresponding bookmark associated items). If a request for the bookmark is not received (i.e., “no” from block 406), then the method continues at block 402 to receive additional bookmark save events. If a request for the bookmark is received (i.e., “yes” from block 406), then at block 408, the request is communicated to the service that updates the bookmark definitions and/or the bookmark associated items. For example, media device 204 communicates the request for a bookmark to the bookmark association service 214 that updates (e.g., late-binds or re-interprets) the bookmark definitions and the corresponding bookmark associated items.

At block 410, the requested bookmark is received along with the bookmark associated items for display. For example, media device 204 receives the bookmark user interface data 222 and the user interface application 226 processes the data to render the bookmark user interface 210 for display at a media device 204. The bookmark user interface 210 can include one or more identifiers of bookmark associated items that correspond to respective selected bookmarks.

FIG. 5 illustrates various components of an example device 500 that can be implemented as any form of a computing, electronic, appliance, and/or media device to implement various embodiments of updated bookmark associations. For example, device 500 can be implemented as a content distributor, a bookmark association service, and/or a media device as shown in FIG. 1 and/or FIG. 2. In various embodiments, device 500 can be implemented as any one or combination of a wired and/or wireless media device, a mobile phone device, a portable computer device, a television client device (e.g., a television set-top box, a digital video recorder (DVR), etc.), a computer device, a gaming system, an appliance device, an electronic device, and/or as any other type of media that may be implemented to receive media content in any form of audio, video, and/or image data.

Device 500 can include one or more media content inputs 502 via which any type of audio, video, and/or image media content 504 can be received from a media content source. The media content inputs 502 can include Internet Protocol (IP) inputs over which streams of media content are received via an IP-based network. Device 500 further includes one or more communication interfaces 506 that can be implemented as any one or more of a serial and/or parallel interface, a wireless interface, any type of network interface, a modem, and as any other type of communication interface. The communication interfaces 506 provide a connection and/or communication links between device 500 and a communication network by which other electronic, computing, and communication devices can communicate data with device 500.

Device 500 can include one or more processors 508 (e.g., any of microprocessors, controllers, and the like) which process various computer-executable instructions to control the operation of device 500, to communicate with other electronic and computing devices, and to implement embodiments of updated bookmark associations. Alternatively or in addition, device 500 can be implemented with any one or combination of hardware, firmware, or fixed logic circuitry that is implemented in connection with signal processing and control circuits which are generally identified at 510.

Device 500 can also include computer-readable media 512, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 500 may also include a recording media 514 to maintain recorded media content 516 (e.g., recorded on-demand media content, or assets) that device 500 receives and/or records.

Computer-readable media 512 provides data storage mechanisms to store media content 504, as well as various device applications 518 and any other types of information and/or data related to operational aspects of device 500. For example, an operating system 520 can be maintained as a computer application with the computer-readable media 512 and executed on the processor(s) 508. The device applications 518 can also include a device manager 522 when device 500 is implemented as a media device and/or as a content distributor, and can include a bookmark association service 524 when device 500 is implemented as a content distributor. In this example, the device applications 518 are shown as software modules and/or computer applications that can implement various embodiments of updated bookmark associations.

When implemented as a television client device, the device 500 can also include a DVR system 526 with a playback application 528 that can be implemented as a media control application to control the playback of recorded media content 516 and/or any other audio, video, and/or image media content 504 that can be rendered and/or displayed for viewing. The recording media 514 can maintain recorded media content that may include the media content 504 when it is received from a content distributor and recorded. For example, the media content 504 can be recorded when received as a viewer-scheduled recording, or when the recording media 514 is implemented as a pause buffer that records the media content 504 as it is being received and rendered for viewing.

Device 500 can also include an audio and/or video input/output system 530 that provides audio data to an audio rendering system 532 and/or provides video data to a display system 534. The audio rendering system 532 and/or the display system 534 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link. In an embodiment, audio rendering system 532 and/or the display system 534 can be implemented as external components to device 500. Alternatively, the audio rendering system 532 and/or the display system 534 can be implemented as integrated components of the example device 500.

Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

FIG. 6 illustrates an example media content distribution system 600 in which various embodiments of updated bookmark associations can be implemented. System 600 facilitates the distribution of media content, content metadata, and/or other associated data to multiple viewers, users, viewing systems, and devices. System 600 includes a content distributor 602 and any number of wired and/or wireless media devices. The media devices can include wireless media devices 604 as well as other client devices that are implemented as components in various client systems 606, each configured for data communication via a communication network 608. Each of the media devices and other client devices can receive media content, program content, program guide data, advertising content, closed captions data, content metadata, and the like from content server(s) of the content distributor 602 via the communication network 608.

The wireless media devices 604 can include any type of device implemented to receive and/or communicate wireless data, such as a portable computer device 610, a media device 612 (e.g., a personal media player, portable media player, etc.), and/or any other wireless media device that can receive content in any form of audio, video, and/or image media content. Each of the client systems 606 can include a respective client device and display device that together render media content in any form of audio, video, and/or image data. A client device in a client system 606 can be implemented as any one or combination of a television client device 614 (e.g., a television set-top box, a digital video recorder (DVR), etc.), a computer device 616, a gaming system 618, an appliance device, an electronic device, and/or as any other type of client device that may be implemented to receive any form of audio, video, and/or image media content.

The communication network 608 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 608 can be implemented using any type of network topology and any network communication protocol, and can be represented or otherwise implemented as a combination of two or more networks. A digital network can include various hardwired and/or wireless links 620, such as routers, gateways, and so on to facilitate communication between content distributor 602 and the various media devices.

System 600 includes a media server 622 that receives content from various content sources 624, such as media content from a content provider, program guide data from a program guide source, and advertising content from an advertisement provider. The media server 622 can represent an acquisition server that receives audio, video, and/or image media content from a content provider; an EPG server that receives program guide data from a program guide source; and/or an advertising management server that receives advertising content from an advertisement provider.

The content sources 624 control distribution of the media content, the program guide data, and the advertising content to the media server 622 and/or to other servers of system 600. The media content, program guide data, and advertising content can be distributed via various transmission media 626, such as satellite transmission, radio frequency transmission, cable transmission, and/or via any number of other wired or wireless transmission media. In this example, media server 622 is shown as an independent component of system 600 that communicates the media content, program guide data, and advertising content to content distributor 602. In an alternate implementation, media server 622 can be implemented as a component of content distributor 602.

Content distributor 602 is representative of a networked content distribution system that provides the media content, program guide data, advertising content, and content metadata to multiple subscribers (e.g., the various media devices and client systems 606). The content distributor 602 can be implemented as a networked operator to control distribution of media content, program and advertising content, and any other audio, video, and/or image content to the media devices and client systems 606.

Content distributor 602 includes various content distribution components 628 to facilitate media content processing and distribution, such as a subscriber manager, a device monitor, and one or more content servers. The subscriber manager manages subscriber data, and the device monitor maintains client state information and monitors the media devices, client devices, and/or the client systems. Although the various managers, servers, and monitors of content distributor 602 (to include the media server 622 in one embodiment) are described as distributed, independent components, any one or more of the managers, servers, and monitors can be implemented together as a multi-functional component of content distributor 602. Additionally, any one or more of the managers, servers, and monitors described with reference to system 600 can implement features and embodiments of updated bookmark associations.

The content distributor 602 can also include communication components 630 that are implemented to facilitate media content distribution to the various media devices and other client devices via the communication network 608. The content distributor 602 can also include one or more processors to process various computer-executable instructions, such as an operating system 632, a device manager 634, and a bookmark association service 636. The content distributor 602 can also include computer-readable media for data storage to maintain bookmark data 638 for embodiments of updated bookmark associations.

Although embodiments of updated bookmark associations have been described in language specific to features and/or methods, it is to be understood that the subject of the appended claims is not necessarily limited to the specific features or methods described. Rather, the specific features and methods are disclosed as example implementations of updated bookmark associations.

1. A method, comprising:
receiving a bookmark save event from a media device when a bookmark is initiated while a video stream of media content is rendered by the media device;
maintaining a bookmark definition that correlates the bookmark with the media content;
determining contextual aspects of the bookmark to identify bookmark associated items that are associated with the media content; and
determining additional bookmark definitions that each correlate a bookmark associated item with the bookmark.

2. A method as recited in claim 1, further comprising receiving a request for the bookmark, and in response to receiving the request, updating the additional bookmark definitions.

3. A method as recited in claim 2, wherein the additional bookmark definitions are updated based on at least one of a day or time when the request for the bookmark is received.

4. A method as recited in claim 2, wherein the additional bookmark definitions are updated based on a profile of a user from which the request for the bookmark is received.

5. A method as recited in claim 2, wherein the additional bookmark definitions are updated based on a media device from which the request for the bookmark is received.

6. A method as recited in claim 2, further comprising updating the bookmark associated items when the request for the bookmark is received.

7. A method as recited in claim 1, further comprising updating the additional bookmark definitions based on previous selections of the bookmark associated items that are correlated with the bookmark.

8. A method as recited in claim 1, wherein the media content is an advertisement, and wherein the bookmark definition is associated with at least one of a product or service offered in the advertisement.

9. A method as recited in claim 1, wherein the media content is a movie, and wherein the bookmark definition is associated with at least one of the movie or a scene in the movie.

10. A content distributor, comprising:
a storage media configured to maintain bookmarks when initiated at media devices as bookmark save events that are associated with video streams of media content that are rendered by the media devices, the storage media further configured to maintain bookmark definitions that correlate the bookmarks with respective media content;
a bookmark association service configured to:
receive a bookmark save event from a media device to create a bookmark;
determine contextual aspects of the bookmark to identify bookmark associated items that are associated with the media content; and
determine the bookmark definitions that each correlate a bookmark associated item with the bookmark.

11. A content distributor as recited in claim 10, wherein the bookmark association service is further configured to update the bookmark definitions when a request for the bookmark is received.

12. A content distributor as recited in claim 11, wherein the bookmark association service is further configured to update the bookmark associated items when the request for the bookmark is received.

13. A content distributor as recited in claim 10, wherein the bookmark association service is further configured to update the bookmark definitions based on at least one of a day or time when a request for the bookmark is received.

14. A content distributor as recited in claim 10, wherein the bookmark association service is further configured to update the bookmark definitions based on previous selections of the bookmark associated items that are correlated with the bookmark.

15. A content distributor as recited in claim 10, wherein the bookmark association service is further configured to update the bookmark definitions based on a profile of a user from which a request for the bookmark is received.

16. A content distributor as recited in claim 10, wherein the bookmark association service is further configured to update the bookmark definitions based on a media device from which a request for the bookmark is received.

17. A content distributor as recited in claim 10, wherein the bookmark save event is received when initiated within an advertisement, and wherein a bookmark definition correlates the bookmark with at least one of a product or service offered in the advertisement.

18. A content distributor as recited in claim 10, wherein the bookmark save event is received when initiated within a movie, and wherein a bookmark definition correlates the bookmark with at least one of the movie or a scene in the movie.

19. One or more computer-readable media comprising computer-executable instructions that, when executed, direct a bookmark association service to:
receive a bookmark save event from a media device when a bookmark is initiated while a video stream of media content is rendered by the media device;
determine contextual aspects of the bookmark to identify bookmark associated items that are associated with the media content;
determine bookmark definitions that each correlate a bookmark associated item with the bookmark; and
update the bookmark definitions when receiving a request for the bookmark.

20. One or more computer-readable media as recited in claim 19, further comprising computer-executable instructions that, when executed, direct the bookmark association service to update the bookmark associated items when the request for the bookmark is received.
